(19) United States
(12) Patent Application Publication
(10) Pub. No.: US 2010/0105344 A1
(43) Pub. Date: Apr. 29, 2010

(54) METHOD AND APPARATUS FOR BIASING A MIXER

(76) Inventors: Dawei Guo, Shanghai (CN); Jian Wang, Shanghai (CN)

Correspondence Address: PERKINS COIE LLP;PATENT-SEA, P.O. BOX 1247, SEATTLE, WA, 98111-1247, US

(21) Appl. No.: 12/263,359

(22) Filed: Oct. 31, 2008

(30) Foreign Application Priority Data
Oct. 28, 2008 (CN) 200810043873.5

(51) Int. Cl. H04B 1/16

(52) U.S. Cl. 455/209

(57) ABSTRACT

A method and apparatus for mixing an input signal in a communications system. The apparatus includes an in-phase mixer, a quadrature mixer, and bias circuits. The in-phase mixer mixes the input signal with an in-phase local oscillator signal. The quadrature mixer mixes the input signal with a quadrature local oscillator signal. The quadrature local oscillator signal is approximately 90° out of phase with the in-phase local oscillator signal. The bias circuits provide DC bias to the in-phase mixer and to the quadrature mixer to balance their outputs.

### CROSS-REFERENCE TO RELATED APPLICATION

This application claims priority to Chinese Patent Application No. 200810043873.5, filed Oct. 28, 2008, the disclosure of which is hereby incorporated by reference in its entirety.

### TECHNICAL FIELD

The present disclosure is related to methods and apparatus for biasing a mixer, for example, in a communications system.

### BACKGROUND

Mixer circuits are often employed in communications systems. For example, mixer circuits and methods may be employed to modulate data components with a carrier wave, to demodulate data components from a modulated signal, to convert a signal from one frequency band to another frequency band, and/or the like. Mixer circuits may be employed in receivers, transmitters, and transceivers (e.g., wired telephones, cable boxes, cable modems, cordless telephones, mobile telephones, amateur radio transceivers, televisions, optical transceivers, etc), and in other devices.

In communications systems, physical layer non-idealities may adversely affect the recovery of clock signals. Within a device, these non-idealities may include propagation delay, signal attenuation, noise, DC offset, non-linearity, quantization error, and/or the like. When a device employs multi-correlator architecture (e.g., separate I and Q paths), phase deviation, amplitude mismatch, and/or the like may present another source of non-idealities. These and other non-idealities may decrease system performance.

### BRIEF DESCRIPTION OF THE DRAWINGS

FIG. 1 is a block diagram of a mixer circuit in accordance with an embodiment of the invention;

FIG. 2 is a schematic diagram of a mixer of FIG. 1 in accordance with an embodiment of the invention;

FIG. 3 is a schematic diagram of a bias circuit of FIG. 1 in accordance with an embodiment of the invention;

FIG. 4 is a schematic diagram of a bias circuit of FIG. 1 in accordance with another embodiment of the invention;

FIG. 5 is a block diagram of a mixer circuit in accordance with another embodiment of the invention;

FIG. 6 is a schematic diagram of a mixer of FIG. 5 in accordance with an embodiment of the invention;

FIG. 7 is a schematic diagram of a bias circuit of FIG. 5 in accordance with an embodiment of the invention; and

FIG. 8 is a schematic diagram of a variable gain amplifier of FIG. 5 in accordance with an embodiment of the invention.

### DETAILED DESCRIPTION

The following disclosure describes several embodiments of the invention. Several details describing well-known structures or processes are not set forth in the following description for purposes of brevity and clarity. Also, several other embodiments of the invention can have different configurations, components, or procedures than those described in this Detailed Description. A person of ordinary skill in the art, therefore, will accordingly understand that the invention may have other embodiments with additional elements, or the invention may have other embodiments without several of the elements shown and described below with reference to the figures.

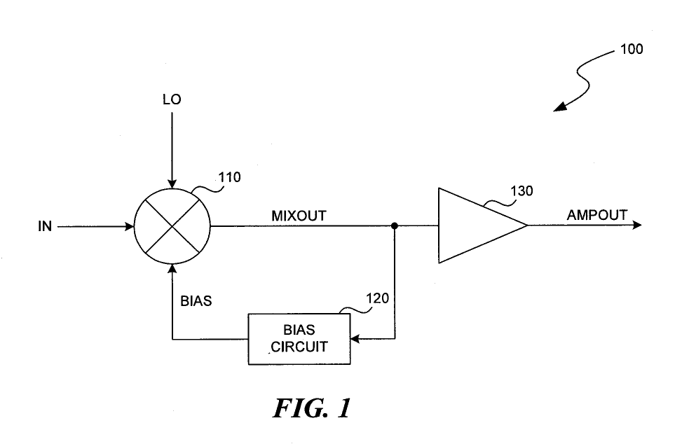

FIG. 1 is a block diagram of mixer circuit 100. As illustrated, circuit 100 includes mixer 110, bias circuit 120, and amplifier 130. In one embodiment, circuit 100 is configured to provide amplifier output signal AMPOUT by mixing input signal IN with local oscillator signal LO. An application specific integrated circuit (ASIC), discrete components, a mixed signal integrated circuit, and/or the like may be employed in circuit 100. Circuit 100 may also include analog circuitry, digital circuitry, and/or mixed analog/digital circuitry.

Circuit 100 may be employed in the receiver, transmitter, or transceiver of communications devices such as cellular phones, wireless phones, wireless network cards, wireless radios, and/or the like. Circuit 100 may also be employed in or by a wide variety of devices and/or systems in which mixers may be employed. For example, wireless communications devices, wired communications devices, interface systems, computing devices, optical media devices, embedded systems, and/or other electronic devices or circuits may employ circuit 100. In one embodiment, circuit 100 is employed in a receiver of a wireless telephone to demodulate input signal IN. In another embodiment, circuit 100 is employed in a transmitter of a wireless telephone to modulate input signal IN.

In one embodiment, signal IN is provided to mixer 110 from an analog to digital converter (ADC), a digital to analog converter (DAC), a radio frequency (RF) receiver, an RF transmitter, and/or the like (not shown in FIG. 1). These and other circuits may be configured to provide input signal IN from a signal that is received over a wired or wireless communications channel, or from a signal to be transmitted over a wired or wireless communications channel. However, input signal IN may be provided from any other suitable source.

In one embodiment, mixer 110 is configured to receive input signal IN, to receive local oscillator signal LO, to receive bias signal BIAS, and to provide mixed signal MIXOUT. Mixer 110 may be configured to mix input signal IN with local oscillator signal LO, and to be biased by bias signal BIAS. For example, mixer 110 may be configured to provide mixed signal MIXOUT based, at least in part, on mixing input signal IN with local oscillator signal LO as biased by bias signal BIAS. Mixed signal MIXOUT may be provided based, at least in part, on multiplying, adding, subtracting, or dividing input signal IN with local oscillator signal LO. In one embodiment, mixer 110 is configured to multiply input signal IN with local oscillator signal LO. Mixer 110 may include a diode circuit, an operational amplifier circuit, an instrumentation amplifier circuit, a difference amplifier circuit, and/or the like.

Bias circuit 120 is configured to receive mixed signal MIXOUT and to provide bias signal BIAS. In one embodiment, bias circuit 120 is configured to provide bias signal BIAS based, at least in part, on mixed signal MIXOUT. For example, bias circuit 120 may be configured to track a DC value on mixed signal MIXOUT and to provide bias signal BIAS based, at least in part, on that DC value. In one embodiment, bias circuit 120 operates as a feedback circuit to stabilize the operation of mixer 110 by level-shifting mixed signal MIXOUT to provide bias signal BIAS.

Amplifier 130 is configured to receive mixed signal MIXOUT and to provide amplifier output signal AMPOUT. Amplifier 130 may provide either unity gain or gain at any suitable non-unity value. Amplifier 130 may include an operational amplifier circuit, an RF amplifier circuit, a power amplifier circuit, a preamplifier circuit, an attenuation circuit, and/or the like.

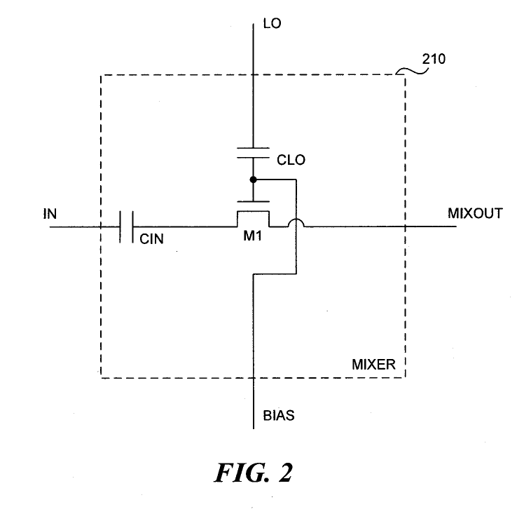

FIG. 2 is a schematic diagram of mixer 210. As illustrated, mixer 210 includes capacitor CIN, capacitor CLO, and transistor Ml. Mixer 210 may be employed as an embodiment of mixer 110 of FIG. 1. Mixer 210 may be configured to provide mixed signal MIXOUT based, at least in part, on input signal IN.

As shown, capacitor CIN and capacitor CLO are configured as DC blocking capacitors to respectively block the DC components of input signal IN and local oscillator signal LO from reaching transistor M1. They may be of any suitable value or type. In addition, the respective values of capacitor CIN and capacitor CLO may be based on expected frequencies on input signal IN and local oscillator signal LO.

In one embodiment, transistor M1 is configured as a mixing transistor to selectively pass an AC value of input signal IN as controlled by an AC value of local oscillator signal LO, as biased by bias signal BIAS. As shown, transistor M1 has a source that is AC coupled to input signal IN, a drain that is coupled to mixed signal MIXOUT, and a gate that is AC coupled to local oscillator signal LO and that is configured to be biased by bias signal BIAS. In one embodiment, transistor M1 is configured such that bias signal BIAS biases a gate-source voltage of transistor M1. However, other variations are within the spirit and scope of the invention. For example, the source of transistor M1 may be AC coupled to input signal IN while the drain is coupled to mixed signal MIXOUT, or local oscillator signal LO may be coupled to the drain while input signal IN is coupled to the gate.

Transistor M1 may include an N-channel metal oxide semiconductor field effect transistor (MOSFET), a P-channel MOSFET, an NPN bipolar junction transistor, a PNP bipolar junction transistor, a junction field effect transistor (JFET), a metal semiconductor field effect transistor (MESFET), an insulated gate bipolar transistor (IGBT), and/or the like. In the illustrated embodiment, bias signal BIAS is coupled to the gate of transistor M1 to bias and/or define an operating point of transistor M1.

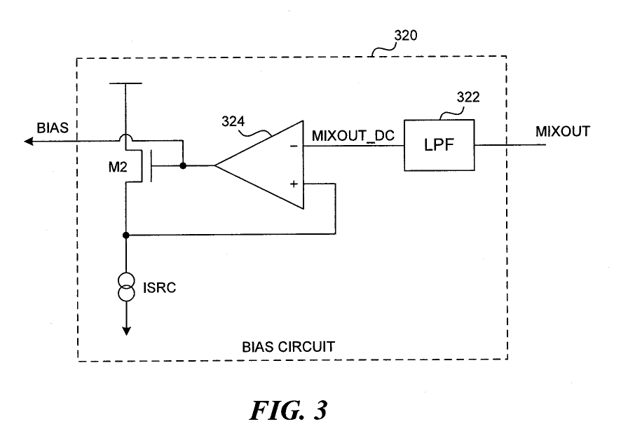

FIG. 3 is a schematic diagram of bias circuit 320. As illustrated, bias circuit 320 includes low-pass filter 322, amplifier 324, transistor M2, and current source ISRC. Bias circuit 320 may be employed as an embodiment of bias circuit 120 of FIG. 1. Bias circuit 320 may be configured to provide bias signal BIAS based, at least in part, on mixed signal MIXOUT.

In one embodiment, amplifier 324, transistor M2, and current source ISRC are configured to operate as a level shift circuit, for example, to sense a DC value of mixed signal MIXOUT on signal MIXOUT_DC via low-pass filter 322 and to provide bias signal BIAS based, at least in part, on the sensed value. Low-pass filter 322 may be any suitable low-pass filter. For example, an RC filter, an RLC filter, a LC filter, an active filter, a digital filter, and/or the like may be suitably employed. In other embodiments, low-pass filter 322 may be omitted, may be coupled to filter the output of bias circuit 320, may be integrated with mixer 110 or amplifier 130 of FIG. 1, and/or the like.

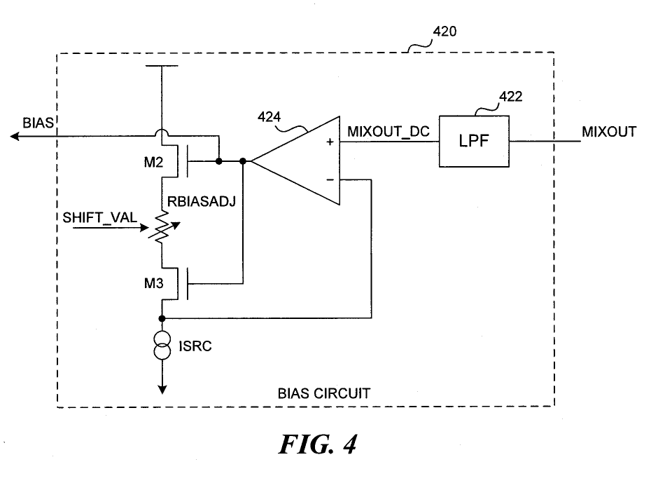

FIG. 4 is a schematic diagram of bias circuit 420. As illustrated, bias circuit 420 includes low-pass filter 422, amplifier 424, transistor M2, transistor M3, current source ISRC, and variable resistor RBIASADJ. Bias circuit 420 may be employed as an embodiment of bias circuit 120 of FIG. 1.

In one embodiment, amplifier 424, transistor M2, transistor M3, current source ISRC, and variable resistor RBIASADJ are configured to operate as a level shift circuit, for example, to sense a DC value of mixed signal MIXOUT on signal MIXOUT_DC via low-pass filter 422 and to provide bias signal BIAS based, at least in part, on the sensed value. In addition, the level shift provided by bias circuit 420 may be configured based on a value of adjustable resistor RBIASADJ, for example, as controlled by shift value signal SHIFT_VAL. In one embodiment, adjustable resistor RBIASADJ is a digitally controlled potentiometer that is configured to receive a digital input on shift value signal SHIFT_VAL. Also, shift value signal SHIFT_VAL may be provided from a microprocessor, a microcontroller, a digital signal processor, a user controlled input, and/or the like (not shown), and may be proportional to the value by which mixed signal MIXOUT is level-shifted to provide bias signal BIAS. In one embodiment, shift value signal SHIFT_VAL may be provided and/or changed to compensate and/or correct for non-linearity over various operating frequencies.

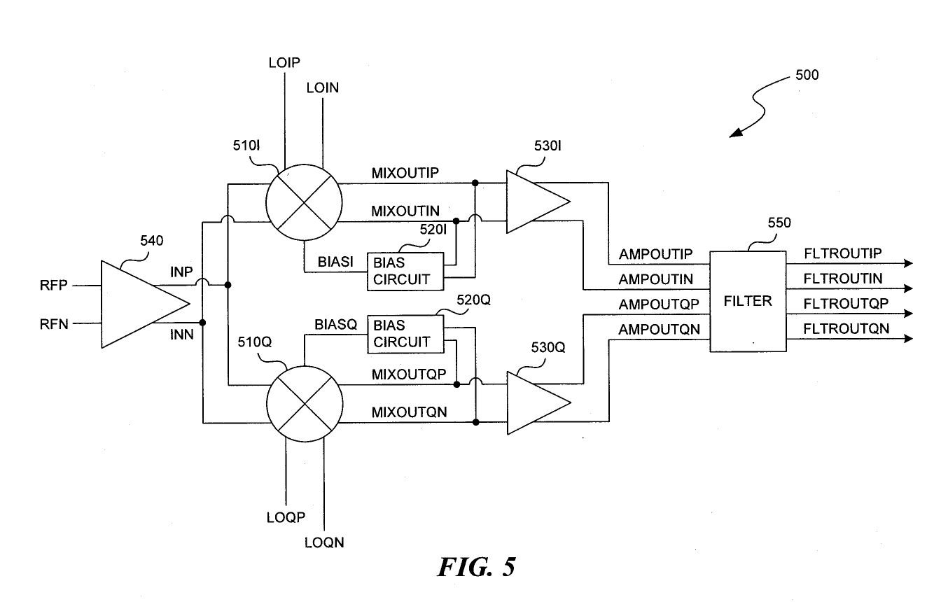

FIG. 5 is a block diagram of mixer circuit 500. As illustrated, mixer circuit 500 includes input amplifier 540, mixer 510I, mixer 510Q, bias circuit 520I, bias circuit 520Q, amplifier 530I, amplifier 530Q, and filter 550.

In one embodiment, circuit 500 is configured as an in-phase/quadrature passive mixer for a low intermediate frequency (IF) circuit in a communications device. Circuit 500 may be employed as a quadrature down conversion mixer or as a quadrature up conversion mixer. Circuit 500 may also be configured as a frequency modulator, frequency demodulator, correlation modulator, correlation demodulator, phase shift keying (PSK) modulator, PSK demodulator, frequency shift keying (FSK) modulator, FSK demodulator, amplitude shift keying (ASK) modulator, ASK demodulator, amplitude phase keying (APK) modulator, APK demodulator, quadrature amplitude modulation (QAM) modulator, QAM demodulator, and/or the like. As shown, circuit 500 is configured with differential signal paths for both an in-phase path and a quadrature path. The in-phase path includes mixer 510I, bias circuit 520I, and amplifier 530I. The quadrature path includes mixer 510Q, bias circuit 520Q, and amplifier 530Q.

Amplifier 540 is configured to receive RF signals RFP and RFN and to provide input signals INP and INN. In one embodiment, amplifier 540 is a differential low noise amplifier (LNA). However, amplifier 540 may also include an RF amplifier, a preamplifier, an attenuator, and/or the like. If circuit 500 is employed in a receiver, amplifier 540 may be configured to receive RF signals RFP and RFN from an antenna. However, if circuit 500 is employed in a transmitter, amplifier 540 may be configured to receive RF signals RFP and RFN from a vocoder, an encryption circuit, an encoder, and/or the like.

Input signals INP and INN are provided to the in-phase path and to the quadrature path. For the in-phase path, input signals INP and INN are provided to mixer 510I where they are mixed with local oscillator signals LOIP and LOIN to provide a mixed in-phase signal component. For the quadrature signal path, input signals INP and INN are provided to mixer 510Q where they are mixed with local oscillator signals LOQP and LOQN to provide a mixed quadrature signal component. In one embodiment, local oscillator signals LOQP and LOQN are provided 90° out of phase with local oscillator signals LOIP and LOIN. Local oscillator signals LOQP and LOQN may either lag or lead local oscillator signals LOIP and LOIN.

Bias circuits 520I and 520Q are respectively configured to provide bias signals BIASI and BIASQ based, at least in part, on the output of mixers 510I and 510Q. As discussed above, bias circuits 520I and 520Q are configured to bias the operations of mixers 510I and 510Q. In one embodiment, bias circuits 520I and 520Q are further configured to balance the operations of mixers 510I and 510Q, for example, to decrease the amplitude mismatch and/or phase error between mixers 510I and 510Q. In at least one embodiment, bias circuits 520I and 520Q may be configured such that bias signal BIASI is substantially the same as bias signal BIASQ.

In certain systems, these imbalances result from layout differences between the in-phase and quadrature paths, component mismatches, component drift, and/or the like. In one embodiment, bias circuits 520I and 520Q are configured such that the amplitude mismatch between the outputs of mixers 510I and 510Q is within 1 decibel (dB) and the phase error is below 5%. The amplitude mismatch may be determined based on measuring peak-to-peak output values, root-mean-square output values, average output values, and/or the like.

Amplifiers 530I and 530Q are respectively arranged to receive the output of mixers 510I and 510Q, and to provide amplifier output signals to filter 550. Amplifiers 530I and 530Q may be any type of suitable amplifier, such as those discussed above. In addition, amplifiers 530I and 530Q may be variable gain amplifiers, as discussed below.

Filter 550 is configured to receive the output of amplifiers 530I and 530Q, and to provide filtered output signals to other circuitry (not shown). Filter 550 may include a surface acoustic wave (SAW) filter, a bulk acoustic wave (BAW) filter, a crystal filter, an RC filter, an RLC filter, an LC filter, and/or the like. In addition, filter 550 may be configured as a high pass filter, a low pass filter, a band pass filter, and/or the like. Filter 550 may also be either an active filter or a passive filter. Filtered output signals FLTROUTIP, FLTROUTIN, FLTROUTQP, and FLTROUTQN may be provided to an RF power amplifier, a pre-amplifier, another amplifier circuit, and/or the like, if circuit 500 is employed in a transmitter. If circuit 500 is employed in a receiver, these outputs of filter 550 may be provided to a signal amplifier, an attenuator, an ADC, a decoder, a decrypter, a vocoder, and/or the like.

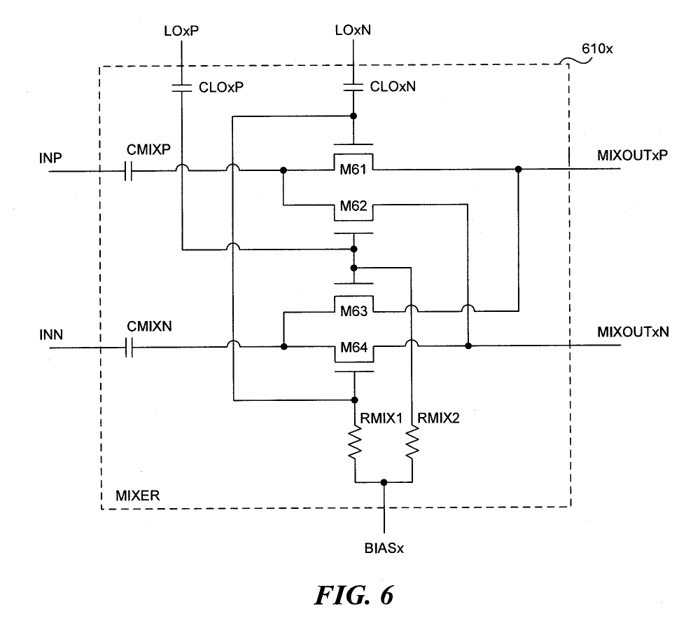

FIG. 6 is a schematic diagram of mixer 610x. As illustrated, mixer 610x includes capacitor CMIXP, capacitor CMIXN, capacitor CLOxP, capacitor CLOxN, transistors M61-M64, resistor RMIX1, and resistor RMIX2. Mixer 610x may be employed as an embodiment of mixer 510I or 510Q of FIG. 5.

In one embodiment, capacitors CMIXP, CMIXN, CLOxP, and CLOxN are configured as DC blocking capacitors and transistors M61-M64 are configured as mixing transistors to mix input signals INP and INN with local oscillator signals LOxP and LOxN. Likewise, resistors RMIX1 and RMIX2 may be configured to receive bias signal BIASx to bias the gates of transistors M61-M64. In one embodiment, bias signal BIASx is provided to bias the DC value of the gate-source voltage of transistors M61-M64 in the in-phase path mixer to the same value as in the quadrature path mixer. For example, this may decrease amplitude mismatch and phase error between the in-phase path and the quadrature path.

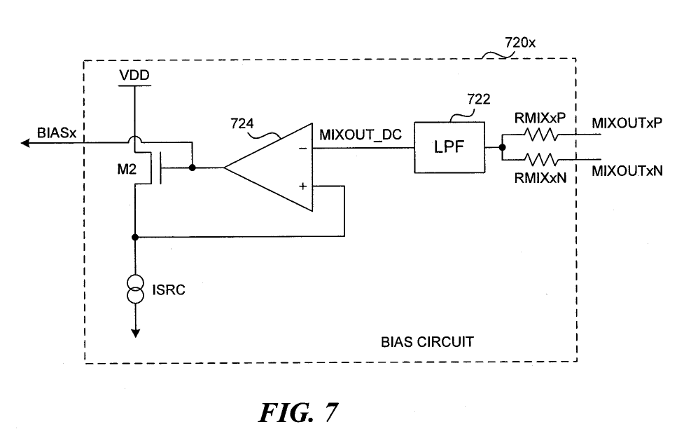

FIG. 7 is a schematic diagram of bias circuit 720x. Bias circuit 720x includes low-pass filter 722, amplifier 724, transistor M2, resistor RMIXxP, resistor RMIXxN, and current source ISRC. Bias circuit 720x may be employed as an embodiment of bias circuit 520I or 520Q of FIG. 5.

In one embodiment, resistors RMIXxP and RMIXxN are configured to provide a single ended input to low-pass filter 722 from differential mixed signals MIXOUTxP and MIXOUTxN. Low-pass filter 722 may be configured to low-pass filter its single ended input to provide the DC components of differential mixed signals MIXOUTxP and MIXOUTxN to amplifier 724. Amplifier 724, transistor M2, and current source ISRC may be configured to operate in a similar fashion to amplifier 322, transistor M2, and current source ISRC of bias circuit 320 of FIG. 3. However, in other embodiments, other bias circuits, whether or not described herein, may be suitably employed. For example, other bias circuits may include adjustable gain, differential circuitry, additional components, other filtration, and/or the like.

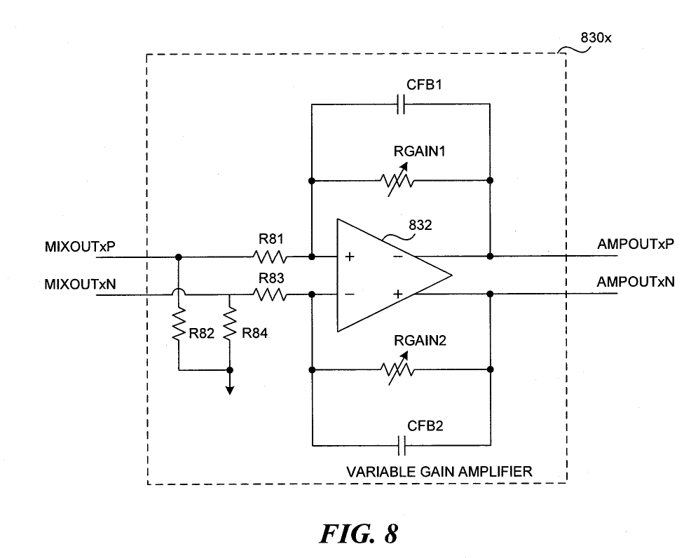

FIG. 8 is a schematic diagram of variable gain amplifier 830x. Amplifier 830x includes resistors R81-R84, capacitor CFB1, capacitor CFB2, adjustable resistor RGAIN1, adjustable resistor RGAIN2, and differential to differential amplifier 832. Variable gain amplifier 830x may be employed as an embodiment of variable gain amplifier 530I or 530Q of FIG. 5.

Variable gain amplifier 830x may be configured to provide gain or attenuation of any suitable unity or non-unity value. For example, the gain of variable gain amplifier 830x may be set by an automatic gain control (AGC) circuit, by a squelch circuit, and/or the like. In addition, the gain of variable gain amplifier 830x may be set based, at least in part, on a frequency of mixed signals MIXOUTxP and MIXOUTxN, on a saturation level for filter 550 of FIG. 5, and/or the like. In addition, the gain may be controlled by setting the values of adjustable resistors RGAIN1 and RGAIN2. For example, the values of adjustable resistors RGAIN1 and RGAIN2 may be digitally controlled by a microcontroller, a microprocessor, a digital signal processor, a user input, and/or the like. In addition, resistors R82 and R84 may be provided as termination resistors for mixed signals MIXOUTxN and MIXOUTxP to improve the DC control of differential to differential amplifier 832.

While the above Detailed Description describes certain embodiments of the invention, and describes the best mode contemplated, no matter how detailed the above appears in text, the invention can be practiced in many ways. Details of the system may vary in implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description explicitly defines such terms. Accordingly, the actual scope of the invention encompasses not only the disclosed embodiments, but also all equivalent ways of practicing or implementing the invention under the claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A circuit for mixing a signal, comprising:
a mixer configured to receive a first signal; to receive a second signal; to receive a bias signal; and to provide a mixed signal that is based, at least in part, on mixing the first signal with the second signal and on biasing the mixer with the bias signal; and
a bias circuit that is configured to receive the mixed signal and to provide the bias signal based, at least in part, on the mixed signal.

2. The circuit of claim 1, wherein the mixer includes:
a mixing transistor having at least a drain, a gate, and a source, wherein the first signal is coupled to the drain, the second signal is coupled to the gate, and the bias signal is provided to bias a voltage between the gate and the source.

3. The circuit of claim 1, wherein the bias circuit includes:
a coupling resistor coupled between the mixed signal and a level-shift circuit; and
the level-shift circuit coupled between the coupling resistor and the bias signal and that is configured to provide the bias signal based, at least in part, on level-shifting the mixed signal by a shift value and on tracking a value of the mixed signal.

4. The circuit of claim 3, wherein the level-shift circuit includes:
a configuration component that is configured to adjust the shift value based, at least in part, on a shift value signal.

5. The circuit of claim 1, wherein the circuit is configured as a passive mixer circuit.

6. The circuit of claim 1, further comprising:
a low noise amplifier configured to provide the first signal;
a variable gain amplifier configured to receive the mixed signal and to provide an amplified signal; and
a filter configured to receive and filter the amplified signal.

7. The circuit of claim 6, wherein the variable gain amplifier is further configured to multiply the mixed signal with a digitally provided gain factor.

8. The circuit of claim 1, further comprising:
a second mixer configured to receive the first signal, to receive a third signal, to receive a second bias signal, and to provide a second mixed signal that is based, at least in part, on mixing the first signal with the third signal and on biasing the second mixer with the second bias signal; and
a second bias circuit that is configured to receive the second mixed signal and to provide the second bias signal based, at least in part, on the second mixed signal.

9. The circuit of claim 8, wherein the second signal and the third signal are local oscillator signals that are approximately 90° out of phase with each other and that have approximately the same peak-to-peak amplitude.

10. The circuit of claim 8, wherein the first signal, the second signal, the third signal, the mixed signal, and the second mixed signal are differential signals.

11. The circuit of claim 8, wherein the bias signal is the same as the second bias signal.

12. The circuit of claim 8, wherein the circuit is configured as one of a frequency modulator, frequency demodulator, correlation modulator, correlation demodulator, phase shift keying (PSK) modulator, PSK demodulator, frequency shift keying (FSK) modulator, FSK demodulator, amplitude shift keying (ASK) modulator, ASK demodulator, amplitude phase keying (APK) modulator, APK demodulator, quadrature amplitude modulation (QAM) modulator, or QAM demodulator.

13. The circuit of claim 8, wherein the circuit is configured to decrease phase error between the mixed signal and the second mixed signal, and to decrease the peak-to-peak amplitude mismatch between the mixed signal and the second mixed signal.

14. A circuit for mixing a signal, comprising:
a first means for mixing an input signal with a local oscillator signal; and
a second means for biasing the first means based, at least in part, on an output of the first means.

15. The circuit of claim 14, further comprising:
a third means for mixing the input signal with another local oscillator signal; and
a fourth means for biasing the third means based, at least in part, on an output of the third means, wherein the local oscillator signal and the other local oscillator signal are approximately 90° out of phase with each other and have approximately the same peak-to-peak amplitude.

16. The circuit of claim 14, wherein the output of the first means represents an in-phase signal component, and wherein the output of the third means represents a quadrature signal component.

17. A method of mixing a signal, comprising:
receiving an input signal;
receiving a local oscillator signal;
employing a mixer to mix the input signal with the local oscillator signal and to provide a mixed signal;
level-shifting the mixed signal to provide a bias signal; and
biasing the mixer with the bias signal.

18. The method of claim 17, wherein level-shifting the mixed signal includes:
receiving a shift value signal; and
level-shifting the mixed signal by a value that is proportional to the shift value signal.

19. The method of claim 17, further comprising:
receiving a second local oscillator signal;
employing a second mixer to mix the input signal with the second local oscillator signal and to provide a second mixed signal;
level-shifting the second mixed signal to provide a second bias signal; and
biasing the second mixer with the second bias signal.

20. The method of claim 19, wherein the local oscillator signal and the second local oscillator signal are approximately 90° out of phase with each other and have approximately the same peak-to-peak amplitude, wherein the mixer is further employed to mix an in-phase signal component, and wherein the second mixer is further employed to mix a quadrature signal component.
